(19) United States
(12) Patent Application Publication
(10) Pub. No.: US 2011/0289168 A1
(43) Pub. Date: Nov. 24, 2011

(54) ELECTRONIC MESSAGING INTEGRITY ENGINE

(75) Inventors: Steven David Allam, Newbury (GB); Manish Kumar Goel, Singapore (SG)

(73) Assignee: BOXSENTRY PTE LTD, REGISTRATION NO. 20061432Z, Singapore (SG)

(21) Appl. No.: 13/133,921

(22) PCT Filed: Dec. 11, 2009
(86) PCT No.: PCT/AU09/01614

§ 371 Date: Aug. 12, 2011

(30) Foreign Application Priority Data
Dec. 12, 2008 (SG) 200809208-2
Jul. 22, 2009 (AU) 2009903425

(51) Int. Cl. G06F 15/16

(52) U.S. Cl. 709/206

(57) ABSTRACT

The disclosure relates to ensuring wanted electronic messages are reliably delivered to recipients by distinguishing between wanted, authenticated messages and other messages. Also, it provides for automatically compiling a datastore with senders of wanted inbound electronic communications. This is done by entering part entries into the datastore as messages are send outbound, and completing the entry as messages are sent inbound or with reference to an external datasource. The whitelist is automatically created and accurately populated and maintained without the need for any human involvement making it self training. This enables mass automation for whitelist generation and maintenance, and enables consistent, scalable deployment across any and all organisations to ensure accuracy in classification of wanted message senders. This disclosure also concerns using the datastore by identifying senders of inbound messages as senders of wanted emails according to a full or part match of their identification information.

### CROSS REFERENCE

Incorporated herein by reference is PCT/AU2006/001571 entitled “Electronic message authentication”, published as WO2007/045049.

### TECHNICAL FIELD

Concerns electronic messaging/communications, such as, but not limited to, email messages. In includes but is not limited to ensuring wanted electronic messages are reliably delivered to recipients by distinguishing between wanted, authenticated messages and other messages. Aspects include methods, software and computer systems for automatically compiling a datastore of information identifying senders of wanted electronic messages and using that datastore as electronic messages are received.

### BACKGROUND ART

Electronic messaging, such as email, SMS and VoIP, is ubiquitous and low cost form of communication between people across publically accessible computer/communications networks, such as the internet. The accessibility and use of electronic messaging is continually increasing in both business and private communities. Further, the senders of electronic messages generally expect their messages to be delivered and to be of value to the recipient.

Generally, electronic messages are sent by humans using computers or by software that has been designed to compile and transmit the same message to many recipients substantially simultaneously on a public communications network. Electronic messaging software can be used not only to transmit, for instance, wanted/solicited newsletters to interest groups, but also to transmit unwanted/illegitimate/unsolicited emails on mass commonly referred to as ‘spam’. A consequence is that many users find their email box filling with wanted emails from both known and unknown senders, and in addition nuisance unwanted emails from unknown senders.

As the volume of unwanted emails grows, more time and resource is consumed in identifying, preventing and/or deleting them. For an organisation, significant resources can be wasted, whether at the individual employee's desktop level or in centralised IT support, and the overall productivity of the organisation can be adversely affected. Moreover, the organisation may be required to invest in additional network storage or consume more bandwidth in order to cope with the extra volume of emails received.

Some organisations attempt to exclude unwanted emails by applying blocking or filtering criteria against the incoming email stream. However, mass emailing operators have responded by disguising their nuisance emails to look like wanted messages thus rendering many of these filtering methods less effective and more likely to cause ‘false positives’ (wanted messages misclassified as unwanted/unsolicited messages).

One method employed to filter unwanted emails is to block the reception of any email according to the sender's email address or IP address.

In other cases mass emailing operators may use fake or non existent return addresses to avoid email address list blocking criteria. Sometimes, they even use the recipient's own email address as the return address.

A further method employed to filter unwanted emails is to block messages according to an analysis of the email's contents. It is possible to attempt to identify unwanted by generic or common language traits or by previously identified statistical profiles of unwanted emails. For example, the email is given a score based on various statistical pattern analysis and any email having a score above a predetermined threshold is considered to be an unwanted email and is not delivered or delivered into a quarantine area (such as a ‘junk’ or ‘spam’ folder).

In general, apart from requiring continual improvement, filtering methods suffer from the disadvantage that valuable emails can be accidentally blocked by inadvertently meeting the filtering criteria. For example, an email between business contacts that includes a word which may be considered to be used in many spam emails (such as ‘mortgage’) thus inadvertently has a score that exceeds the threshold. This results in the false identification of a wanted email as an unwanted email, referred to as a ‘false positive’.

If the combined filtering method of an anti-spam system blocks a percentage of emails incorrectly, over time this will accumulate to a large number of valuable wanted emails that are not received by the intended recipient. This in turn results in potential harm for an organisation due to the loss in wanted communications. This impacts the integrity of the business processes which rely on email to facilitate communication or interaction between the senders and recipients.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the technical field as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A first aspect provides a computer-implemented method for automatically compiling a datastore (such as a whitelist) of information identifying senders of wanted inbound electronic messages sent on a communications network, the method comprising:
(a) receiving an outbound electronic message notification that an outbound electronic message has been or will be sent that includes a first electronic message address of the recipient (i.e. electronic message address of the remote correspondent) of the outbound message;
(b) determining whether the first electronic message address is included in the datastore, and if not, automatically creating a new entry in the datastore for the first electronic message address;
(c) associating with the new entry one or more Internet Protocol (IP) (source) addresses of the first electronic message address, where the IP address is identified from one or more of the following:
   (i) checking a remote or local datastore to identify the IP address associated with the first electronic message address; or
   (ii) receiving an inbound electronic message notification that an inbound electronic message has been or will be received, wherein an electronic message address of a sender of the inbound electronic message is the same as the first electronic message address and identifying the IP address associated with the inbound electronic message.

It is an advantage that a whitelist can be automatically compiled (self-learnt) as electronic messages are sent and received. The whitelist is created and accurately populated and maintained without the need for any human involvement making it self learning. This enables mass automation for whitelist generation and maintenance, and enables consistent, scalable deployment across any and all organisations (large and small) to ensure accuracy in classification of wanted message senders.

This datastore may be presented as a whitelist to the receiving application.

Step (b) may further comprise the step of further determining whether the first electronic message address (i.e. electronic message address of the remote correspondent) is associated in the datastore with a second electronic message address of the sender of the outbound electronic message and if no, only then creating the new entry.

Step (b) may further comprise the step of associating in the datastore the new entry with the second electronic message address.

The wanted inbound electronic message may have as the recipient the second electronic message address.

The remote datastore used may comprise of one or more remote systems that store authentication data for a plurality of electronic message addresses that includes their IP address. The IP address may be associated with the sender's domain or individual email address. Examples include Sender Policy Framework (SPF), Domain Keys Identified Mail (DKIM) or realtime whitelists. This data may be used to validate or be added to the data stored in the local datastore.

For step (c)(i) where a remote database is checked, the IP address may be associated with the entry by performing the check at the time that the entry is accessed to potentially identify a sender of wanted inbound electronic messages.

For step (c)(i), associating in the datastore an IP address with the new entry may be by storing the IP address in the entry or in the datastore in an associated manner, using methods such as through a relationship definition, pointer or included in the entry as commonly used in databases.

The local datastore may be the datastore having the information identifying the senders of wanted inbound electronic messages (i.e. the same datastore).

The method may further comprise:
receiving an inbound electronic message notification that an inbound electronic message has been or will be received that includes a third electronic message address and a third IP address associated with the sender of the inbound electronic message; and
identifying the inbound electronic message as a wanted inbound electronic message by checking that the third electronic message address and the third IP address are included in the datastore.

A second aspect provides a computer-implemented method for automatically compiling a datastore (such as a whitelist) of information identifying senders of wanted inbound electronic messages sent on a communications network, the method comprising:
an input port to receive an outbound electronic message notification that an outbound electronic message has been or will be sent that includes a first electronic message address of the recipient (i.e. electronic message address of the remote correspondent) of the outbound message;
a processor having a query component, storage component, datastorage means and a checking component wherein the datastorage means stores the datastore, the query component operates to determine whether the first electronic message address is included in the datastore, and if not, the storage component operates to automatically create a new entry in the datastore for the first electronic message address and to associate with the new entry one or more Internet Protocol (IP) source addresses of the first electronic message address, where the IP address is identified by:
   (i) a checking component that operates to check a remote or local datastore to identify the IP address associated with the first electronic message address; or
   (ii) the input port receiving an inbound electronic message notification that an inbound electronic message has been or will be received, and the query component operates to determine an electronic message address of a sender of the inbound electronic message is the same as the first electronic message address to identify the IP address associated with the inbound electronic message.

Yet a further aspect provides software, that is computer readable instructions stored on computer readable memory, that when installed and executed by a computer system causes the computer to perform the method described above.

A further aspect provides a computer-implemented method for reducing incorrect identification of wanted inbound electronic messages received from a communications network as unwanted electronic messages, the method comprising the steps of:
(a) receiving a notification of an inbound electronic message, the notification including identification information of (i) an electronic message address of a sender (i.e. remote correspondent) of the inbound message and (ii) an IP address of the sender of the inbound message;
(b) comparing the identification information to entries of identification information of senders of wanted inbound electronic messages in a datastore to attempt to match the identification information to an entry; and
(c) if part of the identification information matches an entry, sending a part match notification, or, if all the identification information matches an entry sending a full match notification.

The information may further include (iii) the electronic message address of the recipient of the inbound message.

An entry in the datastore may comprise an electronic message address of a sender of wanted inbound electronic messages and an IP address of the sender of wanted inbound electronic messages. The entry may further comprise the electronic message address of recipients that want to receive inbound electronic messages from the sender. The entry may contain these values or may have these values by association.

The datastore may be comprised of sub-datastores and in step (b) the sub-datastores may be compared in sequence such that once a full or part match is found no further comparing in step (b) is performed. The first sub-datastore in the sequence may comprise entries relating to a domain and the second sub-datastore in the sequence may comprise entries relating to one or more recipients of electronic messages in the same domain. The notification of step (c) may further include an indication of which sub-datastore the part or full match was made to.

In step (c), part of the identification information that matches may be any one or more of:
(i) only part of (ii), such as a predetermined number of octets,
(ii) only the domain of (i), or
(i) and (ii) but not (iii).

The notification of step (c) may further include an indication of what type of part match was made.

The datastore may be compiled according to the method described above.

The electronic messaging system may be a message transport agent or any other agent that monitors, reports or controls the movement of the electronic messages.

Receiving the notification from and sending the notification to an electronic messaging system. Alternatively, the method may be performed by an internal component of the electronic messaging system itself.

That is the electronic messaging system can distinguish wanted traffic using the outcome of the match. The method may further comprise causing the inbound electronic message to be delivered to the recipient based on whether it is a full or part match. For instance, the system receiving the notification may use this to:
(i) specifically allow the communication or message to continue, over-ruling decisions made by statistical filtering engines which may incorrectly mark the message as unwanted;
(ii) may alert the recipient that a message from a known party has arrived or is starting. Electronic messages may be shown in a users inbox in a different colour to indicate that they are from a wanted authenticated sender. The user's message client software may also be configured to treat the message differently, such as rendering graphics immediately.
(iii) the response used to prioritise certain messages or prevent any throttling/blocking algorithms that may be used by the associated messaging systems, or surrounding systems.
(iv) As the datastore is built using correspondence data, the whitelists generated are specific to each user and their network of contacts, thus the response and action taken to that response can be tailored at a personal level without any manual intervention or additional human process.

One embodiment, allows a method of controlling the flow of electronic messages by using knowledge of wanted senders to partition the incoming flow into two streams. The ‘known’ stream can be allocated more system resource and be operated on immediately. The ‘unknown’ stream can be slowed down, throttled or even temporarily queued or rejected. This gives a further improvement to any existing traffic shaping measures that are in use.

In another embodiment, the electronic message communications may be monitored in a non-invasive way, such as by use of a monitoring port on a network switch. The system will not interrupt the normal flow of communications, but merely observe them. This mode of operation still enables the datastore to be compiled. Those messages from senders in the datastore but not delivered by the filtering system can be deemed to have been incorrectly blocked. A report can be generated for the system administrator detailing those wanted messages that have incorrectly been marked as unwanted.

This allows an administrator to make corrections to the currently running systems to try to avoid the misclassifications.

Further to this, the system may be used to re-inject copies of messages back into the messaging flow, where it has identified a misclassification from monitoring the communications.

In a further aspect provides a computer system for reducing incorrect identification of wanted inbound electronic messages received from a communications network as unwanted electronic messages, comprising:
datastorage means to store a datastore having entries of identification information of senders of wanted inbound electronic messages;
an input port to receive a notification of an inbound electronic message, the notification including identification information of (i) an electronic message address of a sender (i.e. remote correspondent) of the inbound message and (ii) an IP address of the sender of the inbound message;
(b) a query component to compare the received identification information to entries of identification information in a datastore to attempt to match the identification information to an entry; and
(c) an output port to send a part match notification if part of the identification information matches an entry, or, to send a full match notification if all the identification information matches an entry sending.

Another aspect provides software, that is, computer readable instructions stored on a computer readable medium, that when installed and in use causes a computer system to operate in accordance with one or more of the methods described above.

The electronic message may be any one or more of a text, graphic or sound based electronic message.

The electronic messaging system may be a message transport agent (MTA).

The public communications network includes the internet and telephone communications networks.

### BRIEF DESCRIPTION OF THE DRAWINGS

A non-limiting example will now be described with reference to the accompanying drawings:

FIG. 1 is a schematic diagram of the computer system of the example when installed.

FIG. 2 is a schematic diagram of the components of an anti spam system including the example when installed as a software module.

FIG. 3 is flow chart showing compilation of a datastore of information identifying senders of wanted electronic messages (e.g. whitelist).

FIG. 4 is a flow chart showing the use of the datastore to reduce the false identification of unwanted emails.

FIG. 5 is a flow chart showing how the sender of an inbound message is checked against the sub-datastores of the whitelist.

FIG. 6 shows schematically the design of an integrity engine.

### BEST MODES

An example will now be described with reference to the accompanying drawings. In this example the electronic messages are emails, and is used in an interactive query mode operation, as opposed to a monitoring or recovering mode.

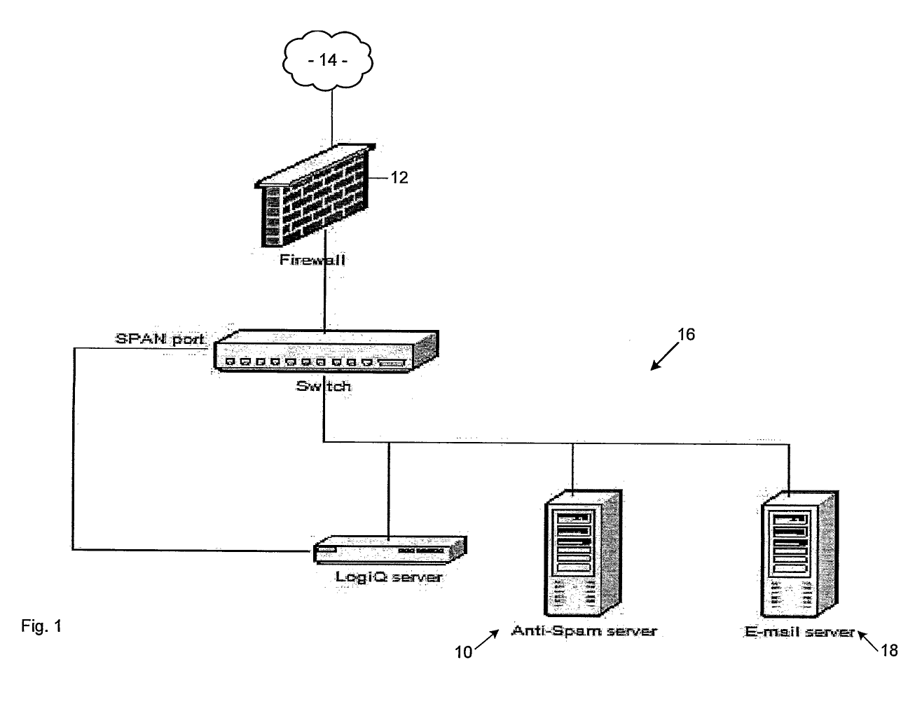

Referring first to FIG. 1, a typical installation of this example involves installing an anti-spam system 10 behind a firewall 12 which protects it from the internet 14. The anti spam system 10 interfaces with a private network 16 via an email server 18. The email server 18 operates as the email server for multiple local domains on the network.

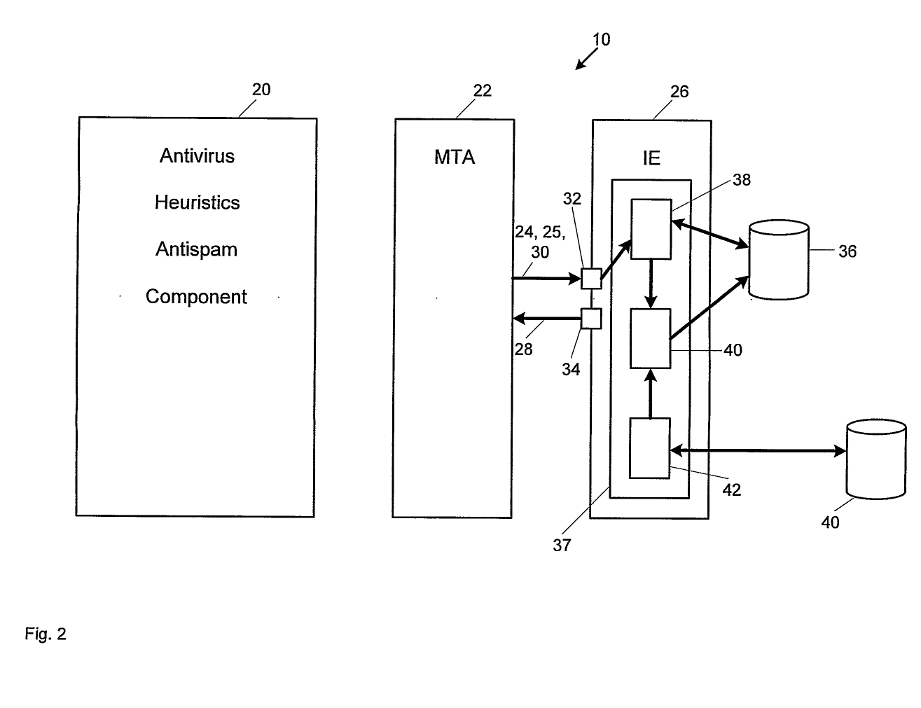

A schematic representation of the anti-spam system 10 is shown in FIG. 2. In this example the integrity engine (IE) 26 is installed as a software module in the anti-spam system 10 residing on the same server 10. Alternatively, it may reside on a separate server located on the same network, or on the Internet.

The anti-spam system 10 has anti-virus, heuristic and anti-spam components 20 that communicate with the message transport agent (MTA) 22. The MTA 22 queries the IE 26 each time an inbound email is received 30 or an outbound email 24 is sent, where the query describes that email (described in further detail below).

The IE 26 includes an additional layer of protection for the anti-spam system 10 by helping to reduce incorrect identification of wanted messages (i.e. false positives) by correctly identifying senders of wanted inbound emails. This shifts the anti-spam focus away from blocking unwanted (i.e. spam) emails into the realms of email protection by ensuring that wanted messages between known parties are delivered. The IE 26 provides the ability to integrate an intelligent whitelisting system into an anti-spam system 10. This provides a significant reduction in false positives and in turn increases the confidence that wanted emails will not be incorrectly blocked by anti-spam systems 10.

The queries are received at an input port 32 of the IE 26. Queries include sufficient information that using which the IE 26 can make a decision 28 on whether the email is from a previously determined valid source using its processor 37 comprised of a query component 38, storage component 40, and checking component 42. The IE 26 then communicates that determination in a notification 28 to the MTA 22 from an output port 34. The MTA 22 then makes use of this notification 28 in any way it wishes, for example standard practice can be modified to suit the needs of that private network that may have very low or high security level requirements.

The IE 26 has datastorage means 36 a datastore, such as a database, usually referred to as a whitelist and in this example the datastore is local to the IE 26. The IE 26 automatically compiles a sender identification datastore, for example local whitelist having more than a single entry list form, such as also including hashes, tables and other information for the private network 16 based on queries 24 that it receives.

Once a query 24 or 30 is received the IE 26 first determines whether the query relates to an inbound or an outbound message. The content of the query may depend on whether it is an outbound email or an inbound email. A full query contains the following information:
I—sender/originator IP address
II—sender/originator email address
III—recipient email address.

### Compiling a Sender Identification Datastore

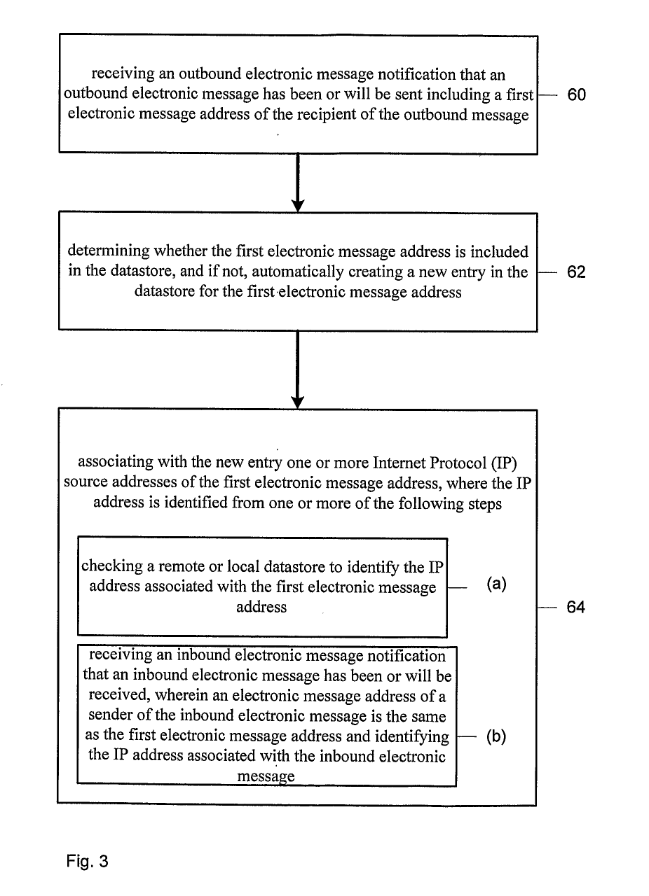

Using queries 24 to automatically compile a sender identification datastore will now be described with reference to FIG. 3.

Once a message is accepted for outbound delivery by the email server 18 a query 24 is received 60 by the IE 26. For an outbound message the query 24 (i.e. notification) will include:
I—the IP address of the sender (i.e. local user) of the outbound message
II—the email address (i.e. second electronic message address) of the sender of the outbound message
III—the email address (i.e. first electronic message address) of the intended external recipient (i.e. remote correspondent)

A configuration file of the IE 26 includes the local domains that the email server 18 is responsible for together with IP addresses for those local mailservers handling those domains. A message is considered an outbound message if after checking the query it is determined that the sender's email address is from one of the local domains and matching IP addresses of the sending mailserver as specified in the configuration file. Alternatively, a query 24 may specify that the message is outbound meaning that the above check is not required and the query 24 would need not include the IP address of the sender.

Every outbound email has a recipient's address (i.e. first electronic message address) that should be included in the sender identification datastore. Next, query component 38 determines 62 whether the second email address is already in the sender identification datastore 36.

In this example the datastore 36 is separated into different sub-datastores. A valid sender can be indentified as sender of wanted emails:
global sub-datastore: globally by inclusion in a remote sender identification datastore stored remotely
network sub-datastore: to the entire network in a network sender identification datastore stored locally
domain sub-datastore: to one or more domains of the network in a domain sender identification datastore stored locally
user sub-datastores: to a particular user on the private network each have their own user-sender identification datastore stored locally

In this example, the recipient of an outbound message is automatically added by the storage component 40 to the sender's (i.e. local user sending the outbound message) sender identification datastore 36. That is, after checking, if the IE 26 determines the recipient of the outbound message is not included in the datastore 36 it is added as a new entry. Initially the entry includes the address of the recipient of the external outbound email plus a NULL entry for the IP address of this remote recipient. This record is associated with the sender of the outbound email, such as by adding a further field to the entry of the email address of the sender of the outbound email.

Alternatively, the recipient of an outbound email is identified in the sender identification datastore 36 but associated with another user. In that case, a new entry will still be added to the local sender's sender identification datastore 36. A person skilled in the art would readily identify that this can also be done in a database by associating the entry for the recipient with a further user.

This part record is then completed from one of the two following ways.

### Checking a Remote or Local Datastore for the IP Address 64a

The part entry can be enhanced with domain specific information and IP addresses should the domain of the recipient have a remote SPF record or other external means 40 available to the IE 26 to determine the IP address of the recipient of the outgoing email.

In this example the checking component 42 sends a query containing the email address of the recipient of the outbound email to an external database 40 that will provide the corresponding IP address if available.

In this example, if this check is unsuccessful, the query component 38 then checks the datastore 36 to identify whether an IP address for the recipient of the outbound email is already captured in the sender identification datastore associated with another user. In that case, that IP address is also used to complete the record.

IP Address Taken from an Inbound Email 64b

When an inbound email is received by the email server 18 a query 25 is passed to the IE 26 after the anti spam components 20 have determined that the inbound email is not spam. This query 25 includes at least:
I—IP address of the sender of the inbound email
II—email address of the sender of the inbound email
III—email address of the recipient of the inbound email

The sender identification datastore of the local user 36, who is the recipient of the inbound email, is queried by the query component 38 to identify whether the sender of the inbound email is in their list and the entry for the sender of the inbound email is incomplete. If so, the email is assumed to be a response to the local user's outbound email. The IP address of the sender of the email is then added to the part record by the storage component 40.

The IE 26 also tracks, amongst other things, the number of times that local users communicate with remote correspondents. This data is used when building the whitelists by limiting entries for remote correspondents where the local user is not in regular or frequent communication with the remote sender.

The IE 26 also generates alerts that can be sent to individual local users or administrators. The alerts can contains details of remote senders that were not found on the sender identification datastore but which should be considered further for possible addition to the sender identification datastore. Alternatively, an administrator may choose to add new entries to the network or domain sender identification datastore.

### Using the Sender Identification Datastore to Reduce False Positive Errors

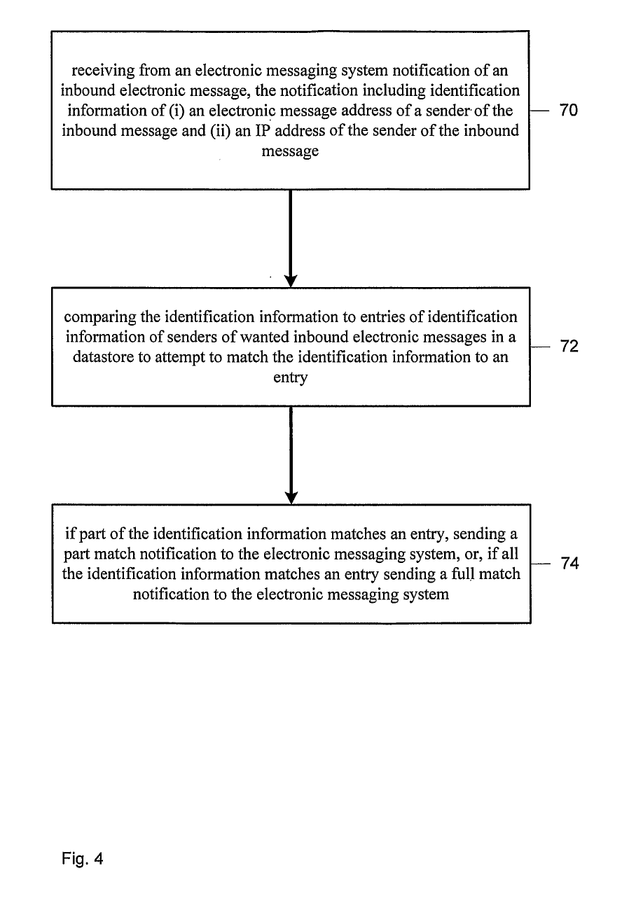

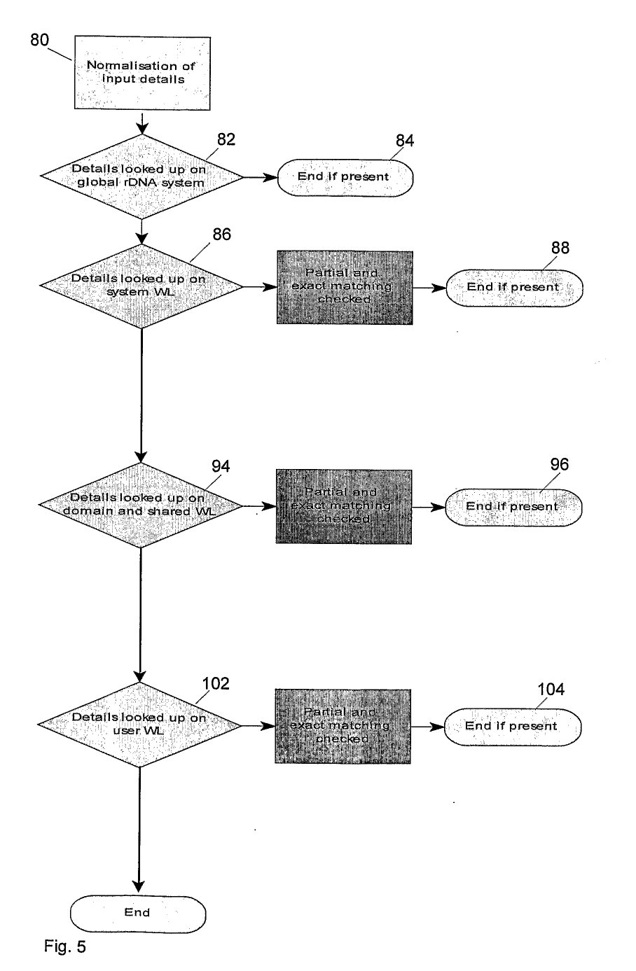

Using the sender identification datastore to reduce false positive detection of unwanted emails will now be described with reference to FIG. 4 and FIG. 5.

When the anti-spam system 10 receives an email, before checking whether the inbound email is spam, a query 30 is sent from the MTA 22 to the IE 26. In this example this query 30 is different to the query discussed in relation to 64b above which is sent after the anti-spam system determines that the email isn't spam.

The IE 26 receives 70 the query 30 (i.e. notification) containing the following identification information:
I—IP address of the sender of the inbound email
II—email address of the sender of the inbound email
III—email address of the recipient of the inbound email

Next the query component 38 compares 72 the identification information with the sender identification datastore 36. This comparison can return different levels of matching:
(i) exact match—all of the identification information was matched in the sender identification datastore
(ii) partial match (IP)—the email address of the sender has been found in the sender identification datastore and the IP address matches to the level specified in the configuration file (i.e. a certain number of octets are the same) OR
(iii) partial match (shared)—the email address has been found in the sender identification datastore but as an entry associated with a different user (i.e. in the sender identification datastore associated with another user within the same domain or domain group).

The IE 26 will return a single notification 28 to the MTA 22 from the output port 34 that includes a response code.

This comparison is shown in further detail in FIG. 5. Initially the notification is normalised whereby the parameters are checked for validity and shifted to lowercase 80. Next the identification information are looked up 82 on an external data source system which is a global whitelist. This step 82 requires the IE 26 to hash the sender's email address and IP address to ensure, for security reasons, that the raw information is not sent to the external data source. In this example the lookup is a DNS lookup, using md5 hashed values. If the identification information is included in the external data source an appropriate further notification is received by the IE 26 from the external data source. This further notification is then converted into the notification 28 including the appropriate response code for this match that is sent to the MTA 22 and the comparing of step 72 ends 84.

Next a look up is performed 86 on the system whitelist which in this example is stored locally on the IE 26. The system whitelist is checked for a match for the senders email address or domain.

If a part match or full match is found, the comparing of step 72 ends 88.

Next a look up is performed on the domain whitelist 94, user whitelist 102 in that sequence. At each stage if a full or part match is made the comparing step 72 ends 96, 104 and 108 respectively.

The domain 94 and user 102 whitelists are checked. In IE 26 there is a separation of these lists 94 and 102. In this example an extra field is provided in each entry to tag each entry as belonging to a particular domain or a particular user which is completed when an entry is added to the datastore.

Also, IE 26 must not only check the user's domain list, but check the users domain group list. If the domain is part of a domain group, then the group of domains can effectively share whitelist data. Thus, anything on the whitelist for a user ‘steve@acme.com’ is effectively on the whitelist for a user ‘steve@acme.co.uk’, assuming that acme.com and acme.co.uk are part of the same domain group.

Note that Bounce Address Tag Validation (BATV) addresses need to be normalised, before checking.

If an exact match can be found in the datastore, then the notification 28 sent to the MTA 22 including this full match code 74. Also, it is possible to have an SPF value passed into the IE 26 as a parameter, to avoid IE 26 carrying out the check itself.

If a full match is not found for the IP address, but there is a match for the email address of the sender of the inbound email, then a notification 28 that a partial match 74 is made is sent to the MTA 22. For partial matches, the IP address should be checked for the number of octets that match records in the datastore. This is used in conjunction with the configuration options in the configuration file, which allows the installer to set this level. Thus, if the configuration is set to 2 leading octet match, the IP address 10.10.23.45 will match 10.10.21.46

If an entry cannot be found in the recipient's user's list, then the email address and IP address will be checked on other users list, without reference to the recipient.

If a match may be found on both originator and IP address on the local user's list (but not the recipient user's list) then a partial match code is returned that indicates that the partial match is based on a shared match result.

What that MTA 22 does with the code included in the notification 28 is also configurable and up to the requirements of that private network. For example, in some systems a shared match may be sufficient to deliver the inbound email to the recipient. In other systems this may not be sufficient and the email is not delivered.

### Configuration File

As mentioned above, the IE 26 configuration file contains static information that can be configured at installation time. However, this information should also be changeable via the Admin API (discussed below). Information held in the configuration file should include (but not be limited to) the following information:
License details
Domain groups
List of internal domains
List of sending mail servers for each domain
Reporting options
Partial match settings

In this example, using the configuration file the user can configure all IE 26 functions so that the IE 26 can be used without resort to the Admin API (i.e. an installation should require a correct configuration file and the IE environment (discussed below) to operate and no further actions.

The configuration file should allow for a single IE 26 instance to process queries 24 and 30 from a number of ‘sites’. Each site will have a different set of domains and users. The configuration file will be in XML format.

The following items should be included in the IE 26 configuration file that is read at start-up. There can be a single default section of the configuration file, or multiple sections (named using the site code).

Configuration items are as follows:

### General

license-code=<our license code>
encryption key, used to de-crypt incoming requests
cache size to specify cache size used by IE 26 (if appropriate)

### Logging

request log location, supporting both windows and Unix path names)
general log location
request log style, syslog or CSV (d=syslog)
request log entries, a list of API commands. If present, only these actions will be logged

### Whitelist Checking

partial-match-level=<num of octets to consider a match>
list-precedence=global, system_white, domain_white, user_white

### Daemon Options

Listen port
Bind IP address

In this example the IE configuration file is dynamic, in that the IE daemon will re-read the configuration after a change, rather than requiring a restart.

The API will also include some commands that result in modifications to the configuration file.

### IE Admin API

The admin API is an integral part of the IE HTTP API. It enables the administrator to:

Configure the necessary start-up parameters for IE. For each domain group:
List of local e-mail domains
List of local IP addresses that e-mail can originate from
Settings for use of shared whitelist and shared black list
Settings for partial IP address matching (no. of octets) for whitelist

Manipulate the whitelists and blacklists
Add or remove entries
List or dump entries

Enable production of reports
For licensing purposes
Resource purposes; data size on disk, memory usage
performance purposes; number of queries handled, query throughput, breakdown of result codes

External applications and MTAs may integrate with IE by using the HTTP interface. It will require the requestor to submit the following information:
originators IP address
originators email address
recipients email address
message direction (inbound or outbound) (optional)
requestors message id (optional)
message subject (optional)

The interface will respond 28 with:
The IE response code, such as one of USER_WL, DOMAIN_WL, SYSTEM_WL, GLOBAL_WL, IP_WL, UNKNOWN, ERROR
The IE sub-code of EXACT (an exact match was found on whitelist or black list), PARTIAL_IP (a partial match was found for IP), or PARTIAL_SHARED (a match was found for another domain user)
The IE reason text, a detailed message explaining why and what the orig/ip matched

The TCP interface may also be extended to allow full Administrative access, such as changing configuration, adding and removing whitelist entries etc.

### Admin/User Consoles

The administrator API encapsulates all the commands necessary to configure and operate IE. It is expected that partners will use the API to integrate IE functions (such as add to whitelist) into their own user and admin interfaces. This could be in form of a graphical user interface (GUI).

### Reporting Module

Reporting will be carried out by using the API functions to determine details on the IE. The reports may be in HTML.

### Logging

IE will log to two log files (a) Request log: All queries made to the API will be logged here, detailing the API call made, the parameters used and the response given

Error log: A general log file for all other logging information. The configuration files specifies where these are saved.

In this example the request log is limited to only log certain queries (simply by listing them in the configuration file) and to have the request log output in either syslog or CSV format.

### Design

The IE is capable of handling a large number of incoming queries, and has the ability to be split across a number of physical servers.

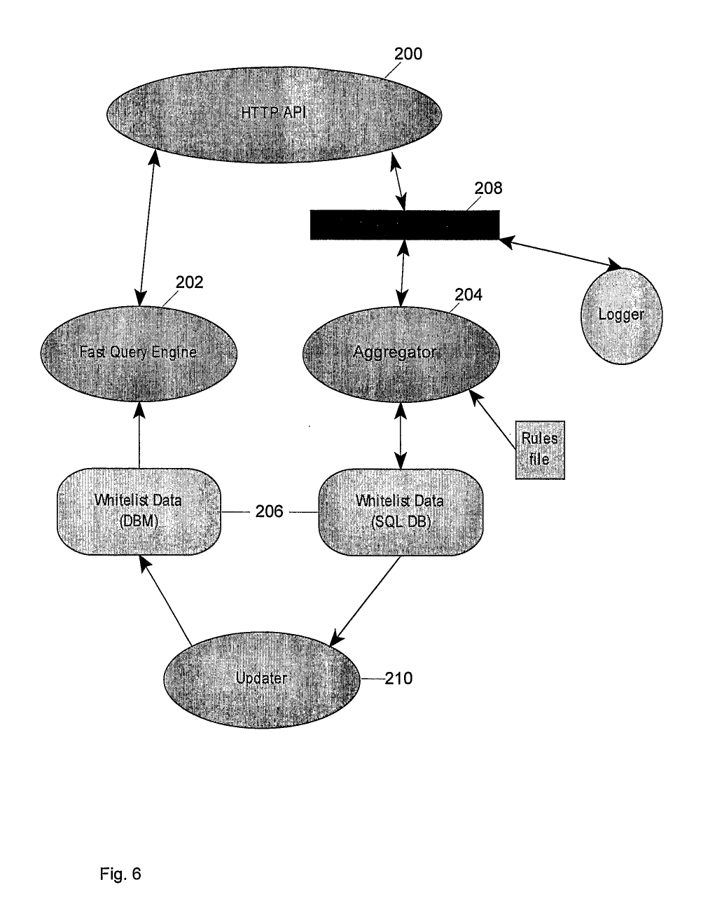

FIG. 6 shows the basic building blocks of a single node IE server. In larger deployments, the IE can be split across multiple servers down the middle of the diagram, with the HTTP API, FQE, DBM data on one server, and the other components on another server, or more than one server.

### HTTP API 200

The HTTP API component is responsible for:
Accepting whitelist lookup requests from clients 30
Accepting whitelist data that is used to build the whitelists 24, 25
Accepting and responding to ‘admin’ requests

Alternatively, the HTTP API 200 could be split across a number of nodes, so that requestors can make admin requests on one node, and other requests another node.

The HTTP API component 200 controls the other sub components, and returns the responses 28 to the requestor. It runs as a daemon.

An admin API request consists of an HTTP POST, using a URL that contains the request command, with the POST body containing an XML stream containing any parameters required for the request. Responses are returned as XML in the body of the returned page. Other (query) requests use standard HTTP GET methods.

The HTTP API may operate using either the HTTP or the HTTPS protocols depending on configuration.

The API controls the calling and responses from the Fast Query Engine (FQE) 202 and Slow Query Engine (SQE) 204. It is possible that both the FQE and SQE return multiple values. The API must return a single value to the requestor.

### Data Storage 206

The data for IE is stored in two places:
A dbm style database for the FQE 202
An extended dbmextended dbm style database for the SQE 204

The dbm database is a simple key/value pair that contains whitelist and blacklist data. The input files for the creation of the dbm databases consist of keys and values as detailed in the following table:

| File | Key | Value |
|---|---|---|
| ip.dat | IP | source domain(s) |
| system.dat | sender/domain | Complex structure detailing |
| | | known recips, IP addresses |
| domaingroup.dat | sender/domain | Complex structure detailing |
| | | known recips, IP addresses |

Thus, each domain group has its own dbm file.

Entries for originator and recipient may contain the * character—not as a wildcard, but to denote wildcard type usage:
Full value: steve@acme.com
Domain only: *@acme.com

The domain only value arises when a user/admin wishes to accept messages from all users at a domain—this value is entered into the whitelist directly. In order to use this data, it becomes necessary to carry out two searches, steve@acme.com and *@acme.com. If either search finds a matching record, then the IE identifies a match.

Due to the nature of the application, its possible that there may be many (even hundreds) of domains being handled, and thus hundreds of dbm files.

The FQE 202 must be able to cache the dbm files to ensure that the most frequently used files are held open.

The extended dbm database contains data in a similar manner to the dbm files, but is used when more complex queries are carried out, as the full power of a rdb can be used when generating search queries.

The extended dbm data consists again of one table for the system black/whitelist and one table per domain group.

### Fast Query Engine (FQE) 202

The FQE is implemented as a component of the HTTP API. The FQE may also be accessed using a DNS type interface.

It is responsible for carrying out fast, exact matches on the static whitelist data, known as ‘simple’ matching. IE may be configured to carry out simple matching only in real time, or to carry out both simple and complex matching in real time.

The FQE queries a (semi) static set of whitelist data, held in a dbm format, described above.

The data in these files is basically a key/value pair. The FQE receives the data from the API and carries out up to 6 queries on the underlying data, looking for:
An exact match for the IP, orig, recip
A match for a IP match
IP/orig match
IP/domain match

So, for a message sent from (1.1.1.1) steve@acme.com→david@bs.com, this data will be processed in order to look up the following keys:

| dbm file | lookup key | Expected result |
|---|---|---|
| system | steve@acme.com, | IP + recip match (or partial |
| | *@acme.com | match) |
| domain group | steve@acme.com, | IP + recip match (or partial |
| | *@acme.com | match) |

The result(s) of the lookups are returned to the API for processing and response to the requestor. The lookups may result in more than one result—i.e. a match may be found in the system list as well as the domain list. In which case, the precedence ordering will be decided by the HTTP API component.

The FQE is capable of processing key lookups in parallel. The FQE handles the absence of a dbm file gracefully, such as. stop and wait for a period before retrying (this is to cover the time period when a dbm file is being re-written by the updater).

### Aggregator 204

The Aggregator 204 is passed data for aggregation from the FQE including new (unseen) IPs, new senders and partial match data.

### Message Queue 208

The Aggregator operates by monitoring a message queue. The message queue may be spread amongst a number of servers.

### Updater 210

The purpose of the updater is to run periodically to extract data from the extended dbm database and update the dbm databases for the FQE.

to determine which messages should be delivered and which require further analysis

This example can be deployed on a large scale—across a whole organisation or a large user base (such as an internet service provider). This example is entirely automated and self-learning, and so while it may automatically create personal datastores at an individual user level, it also creates datastores across an organisation or entire communications network. In this way it can manage large volumes of communication requests while ensuring accurate delivery of these through mass customisation of user preferences.

It will be appreciated by persons skilled in the art that numerous variations and/or modifications may be made to the subject matter shown in the specific embodiments without departing from the scope of the claims as broadly described.

Electronic messaging/communication may be defined as a system that transmits data or provides a communications channel between two parties in an electronic format such as email, SMS or VoIP. The example makes use of the terminology used for email. However, it may be applied to any electronic messaging or communications system that connects two or more parties.

In the example above the IE is installed as a separate software module in the anti-spam system 10. In another alternative installation, the IE may be tightly integrated into the anti-spam system on the same server.

The components of the processor may be a combination of both hardware and software acting on the hardware.

In alternative installations the IE may be on a separate physical machine that is then queried across the network by the anti-spam system. In this case the IE will have a communications port to receive queries 24, 25 and 30 and send the notification 28. It will have it's own processor to perform the method of compiling and using the whitelist as described above. It will have (directly or indirectly) a connection to the Internet so that global whitelist checks can be made with remote databases.

The datastore may be queried in a flexible way. The example above uses an HTTP API to query the datastore. Also used in other implementations are presentation as a DNS zone file and also presentation as a simple text file.

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

The present embodiments are, therefore, to be considered in all respects as illustrative and not restrictive.

1. A computer-implemented method for automatically compiling a datastore of information identifying senders of wanted inbound electronic messages sent on a communications network, the method comprising:
(a) receiving an outbound electronic message notification that an outbound electronic message has been or will be sent that includes a first electronic message address of the recipient of the outbound message;
(b) determining whether the first electronic message address is included in the datastore, and if not, automatically creating a new entry in the datastore for the first electronic message address;
(c) associating with the new entry one or more Internet Protocol (IP) addresses of the first electronic message address, where the IP address is identified from one or more of the following:
(i) checking a remote or local datastore to identify the IP address associated with the first electronic message address; or
(ii) receiving an inbound electronic message notification that an inbound electronic message has been or will be received, wherein an electronic message address of a sender of the inbound electronic message is the same as the first electronic message address and identifying the IP address associated with the inbound electronic message.

2. The computer-implemented method of claim 1, wherein step (b) further comprised the step of further determining whether the first electronic message address is associated in the datastore with a second electronic message address of the sender of the outbound electronic message and if no, only then creating the new entry.

3. The computer-implemented method of claim 2, wherein step (b) further comprises the step of associating in the datastore the new entry with the second electronic message address.

4. The computer-implemented method of claim 2, wherein the wanted inbound electronic message has as the recipient the second electronic message address.

5. The computer-implemented method of claim 1, wherein for step (c)(i) where a remote database is checked, the IP address is associated with the entry by this step at the time that the entry is accessed to potentially identify a sender of wanted inbound electronic messages.

6. The computer-implemented method of claim 2, wherein the method further comprises:
receiving an inbound electronic message notification that an inbound electronic message has been or will be received that includes a third electronic message address and a third IP address associated with the sender of the inbound electronic message; and
identifying the inbound electronic message as a wanted inbound electronic message by checking that the third electronic message address and the third IP address are included in the datastore.

7. A computer system for automatically compiling a datastore of information identifying senders of wanted inbound electronic messages sent on a communications network, comprising:
an input port to receive an outbound electronic message notification that an outbound electronic message has been or will be sent that includes a first electronic message address of the recipient of the outbound message;
a processor having a query component, storage component, datastorage means and a checking component wherein the datastorage means stores the datastore, the query component operates to determine whether the first electronic message address is included in the datastore, and if not, the storage component operates to automatically create a new entry in the datastore for the first electronic message address and to associate with the new entry one or more Internet Protocol (IP) source addresses of the first electronic message address, where the IP address is identified by:
(i) a checking component that operates to check a remote or local datastore to identify the IP address associated with the first electronic message address; or
(ii) the input port receiving an inbound electronic message notification that an inbound electronic message has been or will be received, and the query component operates to determine an electronic message address of a sender of the inbound electronic message is the same as the first electronic message address to identify the IP address associated with the inbound electronic message.

8. Software, that is computer readable instructions stored on computer readable memory, that when installed and executed by a computer system causes the computer to perform the computer-implemented method of claim 1.

9. A computer-implemented method for reducing incorrect identification of wanted inbound electronic messages received from a communications network as unwanted electronic messages, the method comprising the steps of:
(a) receiving a notification of an inbound electronic message, the notification including identification information of (i) an electronic message address of a sender of the inbound message and (ii) an IP address of the sender of the inbound message;
(b) comparing the identification information to entries of identification information of senders of wanted inbound electronic messages in a datastore to attempt to match the identification information to an entry; and
(c) if part of the identification information matches an entry, sending a part match notification, or, if all the identification information matches an entry sending a full match notification, the matched entry being automatically created in the datastore when the sender of the inbound message was a recipient of an outbound electronic message.

10. The computer-implemented method of claim 9, wherein the information further includes (iii) the electronic message address of the recipient of the inbound message.

11. The computer-implemented method of claim 9, wherein an entry in the datastore comprises an electronic message address of a sender of wanted inbound electronic messages and an IP address of the sender of wanted inbound electronic messages.

12. The computer-implemented method of claim 9, wherein the method comprises causing the inbound electronic message to be delivered to the recipient based on whether it is a full or part match.

13. The computer-implemented method of claim 9, wherein the datastore is comprised of sub-datastores and step (b) comprises comparing the sub-datastores in sequence such that once a full or part match is found no further comparing in step (b) is performed.

14. The method of claim 13, wherein the first sub-datastore in the sequence comprises entries relating to a domain and the second sub-datastore in the sequence comprises entries relating to one or more recipients of electronic messages in the same domain.

15. An automatically compiled datastore of information identifying senders of wanted inbound electronic messages sent on a communications network, wherein the datastore is compiled according to the method of claim 1.

16. A computer system for reducing incorrect identification of wanted inbound electronic messages received from a communications network as unwanted electronic messages, comprising:
datastorage means to store a datastore having entries of identification information of senders of wanted inbound electronic messages the entries automatically created in the datastore when the sender of an inbound message was a recipient of an outbound electronic message;
an input port to receive a notification of the inbound electronic message, the notification including identification information of (i) an electronic message address of a sender of the inbound message and (ii) an IP address of the sender of the inbound message;
a query component to compare the received identification information to entries of identification information in a datastore to attempt to match the identification information to an entry; and
an output port to send a part match notification to the electronic messaging system if part of the identification information matches an entry, or, to send a full match notification to the electronic messaging system if all the identification information matches an entry sending.

17. Software, that is computer readable instructions stored on computer readable memory, that when installed and executed by a computer system causes the computer to perform the method according to claim 7.
